(19) United States
(12) Patent Application Publication
(10) Pub. No.: US 2017/0249827 A1
(43) Pub. Date: Aug. 31, 2017

(54) SYSTEM FOR LOCATING A PORTABLE ELECTRONIC DEVICE

(71) Applicant: Connie Walker, Amarillo, TX (US)

(72) Inventor: Connie Walker, Amarillo, TX (US)

(21) Appl. No.: 15/053,081

(22) Filed: Feb. 25, 2016

(51) Int. Cl. G08B 21/24

(52) U.S. Cl. CPC G08B 21/24

(57) ABSTRACT

A system for locating a portable electronic device that includes: a key ring; a FOB attached to the key ring; an electronic signal transmitted between the FOB and the portable electronic device; a signal strength associated with the electronic signal, where the signal strength varies based upon distance between the FOB and portable electronic device; operating instructions stored on memory of the portable electronic device; and an alert adapted to transmit from the portable electronic device when the predetermined signal strength diminishes to a predetermined level. The electronic signal includes a Bluetooth signal or a RF signal. The operating instructions may be retrieved and stored via a communication network.

### BACKGROUND OF THE INVENTION

Field of Invention

The present invention relates to a system for locating a portable electronic device that uses signal transmissions.

Description of Related Art

Portable electronic devices such as cell phones, tablets and smartphones are widely used throughout society. Essentially most individuals own some form of a portable electronic device. As a result, many individuals have trouble locating these devices that are occasionally misplaced. A substantial amount of time and frustration may be avoided if a system is developed in order to assist users in finding and locating their portable electronic devices.

### SUMMARY OF THE INVENTION

The present invention relates to a system for locating a portable electronic device that includes: a key ring; a FOB attached to the key ring; an electronic signal transmitted between the FOB and the portable electronic device; a signal strength associated with the electronic signal, where the signal strength varies based upon distance between the FOB and portable electronic device; operating instructions stored on memory of the portable electronic device; and an alert adapted to transmit from the portable electronic device when the predetermined signal strength diminishes to a predetermined level. The electronic signal includes a Bluetooth signal or a RF signal. The operating instructions may be retrieved and stored via a communication network.

### BRIEF DESCRIPTION OF DRAWINGS

FIG. 1 depicts a system for locating a portable electronic device in accordance with the present invention.

### DETAILED DESCRIPTION

The present invention relates to a system for locating a portable electronic device that uses a key ring that includes an electronic FOB. The electronic FOB transmits a signal that connects to portable electronic devices such as a smartphone or tablet. This signal may be integrated into an application installed on the smartphone. A signal transmitted from the FOB is maintained and regulated through the system or application provided on the portable electronic device. Signal strength as a result varies based upon the distance from the FOB to the smartphone. The program provided on the smartphone initiates an alert if a predetermined distance is achieved between the key ring and smartphone of the present invention. This alert therefore alerts the user as to the location or essentially as a reminder of the position of the portable electronic device. This predetermined distance may be set through a preset condition programmed within the application. Based upon this protocol, the present invention alerts the user before going out of range of the portable electronic device, thus avoiding leaving the portable electronic device in an unintended location.

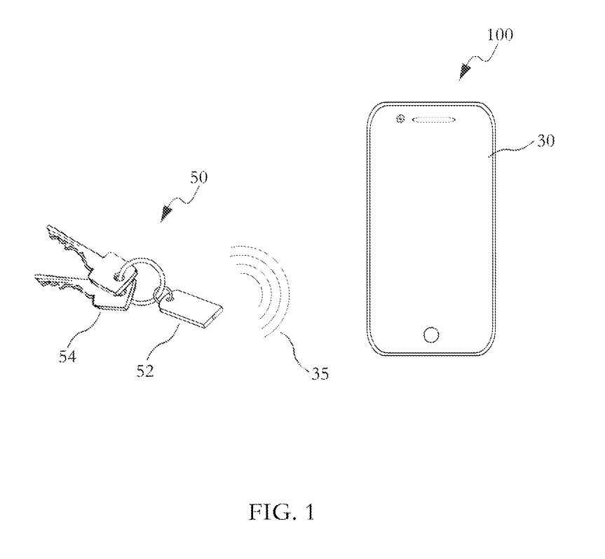

In reference to FIG. 1, a Key Ring 50 in accordance with the present invention is depicted. The Key Ring 50 includes a FOB 52 that transmits a Signal 35. The Signal 35 is transmitted to an Electronic Device 100 that includes an Application 30 installed within the memory of the Electronic Device 100. The Application 30 includes operating instructions related to the use and operation of the Key Ring 50 with the FOB 52. The operating instructions may be retrieved via a communications network connection such as an Internet connection. The Signal 35 may be an RF signal or Bluetooth signal that is monitored in strength during operation.

A sequence of programming provided in the Application 30 alerts the user if the signal strength of Signal 35 diminishes below a predetermined threshold. Once below the threshold an audible or visual alert is triggered on the smartphone. The predetermined signal threshold of Signal 35 may be set using the Application 30. Use of this system therefore helps the user to locate and maintain the location of the portable electronic device though the use of signal strength and appropriate self-aware applications. The instant invention has been shown and described in what it considers to be the most practical and preferred embodiments. It is recognized, however, that departures may be made there from within the scope of the invention and that obvious modifications will occur to a person skilled in the art.

1. A system for locating a portable electronic device comprising:
a. a key ring;
b. a FOB attached to the key ring;
c. an electronic signal transmitted between the FOB and the portable electronic device;
d. a signal strength associated with the electronic signal, where the signal strength varies based upon distance between the FOB and portable electronic device and said signal strength transmits to the portable electronic device at a variable rate;
e. operating instructions stored on memory of the portable electronic device; and
f. an alert adapted to transmit from the portable electronic device when the predetermined signal strength diminishes to a predetermined level.

2. The system for locating according to claim 1, where the electronic signal includes a Bluetooth signal.

3. The system for locating according to claim 1, where the electronic signal includes a RF signal.

4. The system for locating according to claim 1, where the operating instructions are retrieved and stored via a communication network.

5. A method of locating a portable electronic device comprising the steps of:
a. attaching a FOB to a key ring;
b. retrieving operating instructions via a communication network connection;
c. storing the operating instructions onto memory of the portable electronic device;
d. setting operating parameters using the operating instructions, where operating parameters include a predetermined signal strength, where the predetermined signal strength correlates to a distance between the FOB and portable electronic device;
e. setting a variable rate of signal transmission to the portable electronic device; and
f. activating alert protocols related to the predetermined signal strength, where alerts are activated when the predetermined signal strength diminishes to a preset level.
